(19) United States
(12) Patent Application Publication
(10) Pub. No.: US 2010/0135138 A1
(43) Pub. Date: Jun. 3, 2010

(54) OPTICAL DISK DRIVE AND METHOD OF DETERMINING WRITE STRATEGY THEREOF

(75) Inventors: Toshiaki SUZUKI, Yokohama (JP); Shin KAGAMI, Yokohama (JP)

Correspondence Address: STANZIONE & KIM, LLP, 919 18TH STREET, N.W., SUITE 440, WASHINGTON, DC, 20006, US

(73) Assignee: Samsung Elecstronics Co. Ltd, Suwon-si (KR)

(21) Appl. No.: 12/621,641

(22) Filed: Nov. 19, 2009

(30) Foreign Application Priority Data
Nov. 28, 2008 (JP) 2008-305729
Aug. 31, 2009 (KR) 2009-0081085

(51) Int. Cl. G11B 7/00; G11B 27/36

(52) U.S. Cl. 369/53.11; 369/124.1; G9B/7; G9B/27.052

(57) ABSTRACT

An optical disk drive, and a method of determining a write strategy thereof. In the method of determining a write strategy of an optical disk drive where a mark and a space are formed on an optical disk by a laser beam to display write information and information is written or reproduced, write quality is evaluated by combining at least two of power- and pulse-based parameters defining a writing multi pulse, and the at least two parameters are changed on a 2-dimensional matrix. The power- and pulse-based parameters indicating specific write quality are determined as strategy parameters, based on evaluated results of the write quality.

### CROSS-REFERENCE TO RELATED APPLICATIONS

This application claims priority under 35 U.S.C. §119 of Japanese Patent Application No. 2008-305729, filed on Nov. 28, 2008, and Korean Patent Application No. 2009-0081085, filed on Aug. 31, 2009, the entire contents of which are hereby incorporated by reference.

### BACKGROUND

1. Field of the Invention

The present disclosure herein relates to an optical disk drive. More particularly, the present disclosure relates to a method of determining write strategy and an optical disk drive that can determine optimal write strategy for the optical disk drive having unknown write strategy in a short time and precisely.

2. Description of the Related Art

Writing of information onto an optical disk is performed by converting write information provided from a personal computer (PC) or the like into eight-to-fourteen modulation (EFM) signals. However, a composition difference between used optical disks may change the heat storage or a cooling rate of a recording medium. Since the above features may cause a mark failure, etc., a desired mark or space cannot be formed even when it is attempted to write EFM signals without any change to the signals.

Due to the foregoing reasons, a way to determine an inherent write parameter (hereinafter referred to as ‘write strategy’) to each of used optical disks and maintain good write quality is employed with respect to a write waveform used as a reference. However, to determine a write strategy inherent for each used optical disk, a developer's burden is so heavy, and moreover, a response to write strategy for optical disks, for example, selling after the completion of development of a disk drive, is difficult.

In adjustment of strategy for a rewritable disk, it is common to determine the write strategy which guarantees write characteristics from a Direct Over Write DOW(0) performing a write operation on an unwritten region to a Direct Over Write DOW(1000) performing rewrite operations 1000 times. In the typical case, write characteristics and write conditions of DOW(0) and DOW(1000) are in the relation of trade-off each other. To this end, in adjustment of strategy, it is important to balance each in a short time, efficiently.

In the current circumstance, the adjustment of strategy is initiated on the basis of recommendation strategy of a disk or existing adjustment completion strategy, and when a write characteristic of DOW(1) performing a one-time rewrite operation is satisfied, a write characteristic of DOW(1000) is measured. As the result of the measurement, when an attempt to secure a sufficient power margin fails, each pulse width of a cleaning pulse, a multi pulse, a last pulse and a cooling pulse, a peak power, a comparison value between the peak power and an erase power are compositely changed, massive data on write characteristics of DOW(0)-DOW(1000) are obtained, and strategy that can secure a sufficient power margin is selected and determined. Accordingly, enormous time is taken for adjustment of strategy.

Japanese Laid-Open Patent Publication No. 2005-038473 discloses an information recording and reproducing device which sets different pulse widths of multi-pulses of which the power levels include a recording power, a deleting power, and a bottom power, and a light emitting pattern of which the recording power is made to vary at two or more levels at each bottom power, by a pulse setting means and a power setting means, and performs pre-writing to an optical disk, performing over-writing to the pre-written area, evaluates the reproduction signals by a reproduction signal evaluation means, determining the pulse width and bottom power with which a power margin of the recording characteristic satisfies a predetermined reference value, determining the recording power as the optimal recording power, which is able to secure the recording characteristic at the center of the power margin under the set conditions.

Japanese Laid-Open Publication No. 2006-260668 discloses an optical disk device. In this cited reference, in a memory of a system controller, a table, in which the optimal recording strategy is set, is stored for each of identification information for an optical disk. The average recording strategy is set to the optical disk having no identification information. Test data is recorded with the average record strategy and, the strategy, in which a detection rate for a synchronizing signal is a predetermined value or more, is set as the optimal strategy.

However, both of Japanese Laid-Open Patent Publication No. 2005-038473 and Japanese Laid-Open Publication No. 2006-260668 do not consider the write quality of DOW(1000).

Japanese Laid-Open Publication No. 2008-016164 discloses an optical disk device and recording strategy determination method. In this reference, a control section reads, when a loaded optical disk is unknown, a recommended recording strategy from the predetermined area of the loaded optical disk, and reads a correction parameter corresponding to the loaded optical disk from a memory. The control section corrects the read recommended recording strategy based on the correction parameter, and converts a recording pattern into a recording pulse based on the corrected recommended recording strategy. After the conversion of the recording pattern into the recording pulse, the control section executes OPC, and then starts real data recording.

However, it is difficult to guarantee qualities of all disks only by correcting the recommended recording strategy.

### SUMMARY

The present disclosure provides a method of determining a write strategy and an optical disk drive that can determine optimal write strategy for the optical disk drive having an unknown write strategy in a short period of time and precisely.

Additional aspects and utilities of the present general inventive concept will be set forth in part in the description which follows and, in part, will be obvious from the description, or may be learned by practice of the general inventive concept.

Embodiments of the inventive concept provide methods of determining a write strategy of an optical disk drive including: evaluating write quality by combining at least two of power- and pulse-based parameters defining a writing multi pulse, and changing the at least two parameters on a 2-dimensional matrix; and determining the power- and pulse-based parameters indicating specific write quality as strategy parameters, based on evaluated results of the write quality.

In some embodiments, the evaluating of the write quality may include calculating a write power that the write quality of a Direct Over Write (DOW) performing rewrite operation becomes a desired limit value, by changing a value of one of the at least two parameters.

In other embodiments, during the determining of the parameters, one of parameters, which the write power corresponds to a target value, may be determined as a strategy parameter.

In still other embodiments, the methods may further include determining a final strategy parameter by adding or subtracting a predetermined correction amount to/from one of the parameters.

In even other embodiments, the rewrite time may be once.

In yet other embodiments of the inventive concept, optical disk drives where a mark and a space are formed on an optical disk by laser beam to display write information and information is written or reproduced, include: a write strategy operation control unit configured to write quality by combining at least two of power- and pulse-based parameters defining a writing multi pulse and changing the at least two parameters on a 2-dimensional matrix, and configured to determine the power- and pulse-based parameters indicating specific write quality as strategy parameters, based on evaluated results of the write quality; and a write pulse adjustment unit configured to generate and output a write pulse train by referring to the determined strategy parameter

According to exemplary embodiments of the inventive concept, it is possible to realize a method of determining write strategy of an optical disk drive and an optical disk drive, which can determine optimal write strategy for the optical disk drive having unknown write strategy in a short time and precisely.

In yet other embodiments of the inventive concept, a method of determining a write strategy of an optical disk drive includes: setting a write quality by changing values of at least two arbitrary parameters among power- and pulse-based strategy based parameters into a 2-dimensional matrix; and determining optimal values of the power- and pulse-based strategy parameters indicating a specific write quality as strategy parameters, based on the set results of the write quality.

In yet other embodiments of the inventive concept, an optical disk drive, includes: a write strategy operation control unit configured to set a write quality by changing values of at least two arbitrary parameters among power- and pulse-based strategy based parameters into a 2-dimensional matrix, and to determine optimal values of the power- and pulse-based strategy parameters indicating a specific write quality as strategy parameters, based on the set results of the write quality; and

a write pulse adjustment unit configured to generate and output a write pulse train by referring to the determined strategy parameter.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a flowchart illustrating a method of determining write strategy according to an embodiment of the inventive concept;

FIG. 2 is a pulsed waveform diagram illustrating a multi pulse of a subject strategy parameter;

FIG. 3 is a write quality table achieved when a last pulse width and a cooling pulse width in DOW(1) change 2-dimensionally;

FIG. 4 is a write quality table achieved when a last pulse width and a peak power in DOW(1) change 2-dimensionally;

FIG. 5 is a graph illustrating Pp-PIE characteristics using a last pulse width as a parameter in DOW(1);

FIG. 6 is a graph illustrating Tlw-Ppl characteristics showing the relation between a last pulse width and a lower-limit peak power;

FIG. 7 is a power margin diagram showing the relation between a peak power and a block error rate by using a rewrite number as a parameter;

FIG. 8 is a graph showing the correlation, for a last pulse, among a lower-limit peak power, an upper-limit peak power, and a power margin;

FIG. 9 is a maximum value table obtained by calculating Tlw corresponding to the minimum lower-limit peak power of each disk and Tlw corresponding to the maximum power margin, through an approximate quadratic function;

FIG. 10 is a basic functional block diagram of an optical disk drive performing a method according to the inventive concept; and

FIG. 11 is a write quality table achieved when ε and a peak power change 2-dimensionally in DOW(1).

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

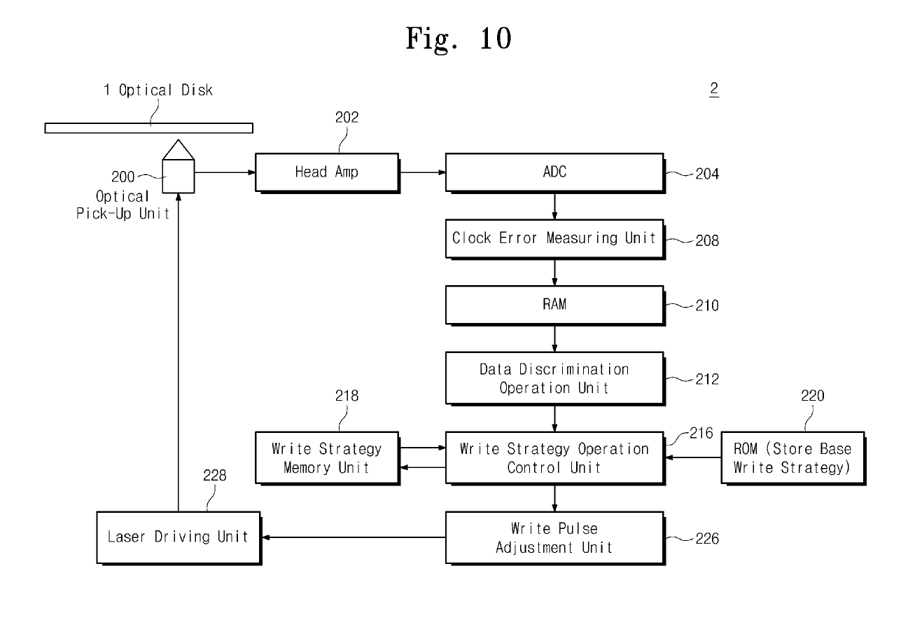

FIG. 10 is a basic functional block diagram of an optical disk drive to perform methods according to embodiments of the present inventive concept. In FIG. 10, an optical disk 1 is an optical medium where data can be written, reproduced and erased (only in RW and RAM) by a semiconductor laser. For example, the optical disk 1 may include a CD-R, CD-RW, DVD±R, DVD-RW, DVD-RAM, and the like.

A ROM 220 is a nonvolatile memory in which recommendation write strategy for an unknown disk or an existing adjustment completion write strategy is stored. Write strategies corresponding to various kinds of disks are stored in the ROM 220 by a designer. A write strategy memory unit 218 temporarily stores write strategy memory parameters calculated by a write strategy operation control unit 216.

The write strategy operation control unit 216 sets initial conditions of each strategy, based on the recommendation write strategy or existing adjustment completion write strategy, which is read out from the ROM 220. The write strategy operation control unit 216 sends the set data to a write pulse adjustment unit 226, and has predetermined data written onto the optical disk 1. Also, a data discrimination operation unit 212 performs operations on the calculated results (described above) from the write strategy operation control unit 216, based on record results written according to the initial conditions, and then determines a peak power Pp and ε (ε=erase power (Pe)/peak power (Pp), to be described later) providing the best write quality.

In addition, to determine a pulse width of a subject strategy parameter according to embodiments of the inventive concept on the basis of Pp and ε, the write quality may be set to required conditions by changing values of two arbitrary parameters, among power- and pulse-based strategy parameters (e.g., pulse widths such as a top pulse width, a top cleaning pulse width, a multi pulse width, a last pulse width and a cooling pulse width, and power-defining parameters such as a peak power, an erase power, a bias power, and a comparison value (ε) between the peak power and the erase power), into a 2-dimensional matrix. Also, a pulse width of a subject strategy parameter may be determined by setting conditions to calculate the minimum value of a lower-limit peak power of DOW(1) or DOW (50 times or less) of an arbitrary single parameter. Alternatively, a pulse width of a subject strategy parameter may be determined by correcting a strategy parameter corresponding to the minimum value of a lower-limit peak power and sending the corrected strategy parameter to the write pulse adjustment unit 226.

Subsequently, the comparison and determination are executed on the basis of the results calculated by the data discrimination operation unit 212 using the record results, and optimal values of the power- and pulse-based strategy parameters, which exhibit the optimal write quality, are then determined. That is, the optimal value of two parameters are determined using maximum and minimum positions of the write quality on a 2-dimensional matrix, a central value of slice levels, or a position calculated from the central value. Also, a value corresponding to the minimum value of a lower-limit peak power in DOW(1) may be determined as an optimal value of a strategy parameter, or the optimal value may be determined by adding or subtracting a predetermined correction amount to/from the value of the strategy parameter corresponding to the minimum value. By repetitively performing this operation on other strategy parameters or combinations thereof, the determination of the optimal value is made upon all or a portion of the strategy parameters. Here, data of the optimal pulse width of the determined subject strategy parameters are stored in the write strategy memory unit 218, and appropriately read out during a user's operation.

The write pulse adjustment unit 226 receives pulse-setting parameter data from the write strategy operation control unit 216, generates a write pulse train, and outputs the write pulse train to a laser driving unit 228. The laser driving unit 228 generates a pulse signal to drive a laser diode in response to the input write pulse, and outputs the pulse signal to a semiconductor laser in an optical pick-up unit 200. The semiconductor laser writes predetermined data onto the optical disk 1.

A head amp 202 calculates the amount of reflected light that the optical pick-up unit 200 detects from the optical disk 1, and generates an RF signal indicating the total light quantity. In addition, the head amp 202 generates a focus error signal to detect a focus error of the semiconductor laser in the optical pick-up unit 200, and a tracking error signal to detect an error in track.

An analog-to-digital conversion (ADC) circuit 204 is a reproduce signal generation circuit that forms a detection signal from the head amp 202 and generates a binary digital signal according to marks and spaces. That is, the ADC circuit 204 digitalizes various analog signals of 3T, 4T, 5T . . . output from the head amp 202, and always adjusts a threshold value for correcting the waveform of a pulse.

A clock error measuring unit 208 measures a judgment parameter to determine the pulse width of the subject strategy parameter. That is, the clock error measuring unit 208 receives data from the ADC circuit 204, and measures an error between an edge of each signal and a clock edge. According to given conditions, a pulse edge of the write pulse train increases or decreases in specification amount (ΔT). At this time, a variation (dT) of a mark edge is actually measured. Here, the write quality may correspond to each error.

A RAM 210 is a memory temporarily storing data measured from the clock error measuring unit 208. That is, the RAM 210 stores clock errors of various signals set by the write strategy operation control unit 216, number of samples of various signals, and variations (dT) of mark edges actually measured when the specification amount (ΔT) of a reproduce signal written in another write strategy moves.

The data discrimination operation unit 212 calculates errors in variations of respective signals set by the write strategy operation control unit 216 by using the measured data stored in the RAM 210. The calculated data are output to the write strategy operation control unit 216 such that the write quality corresponds to each error.

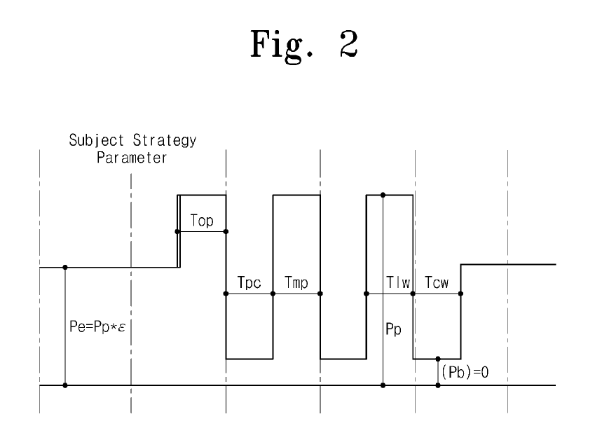

Thereafter, a strategy parameter used in the embodiments of the present inventive concept will be described below. FIG. 2 is a pulsed waveform diagram illustrating a multi pulse of a subject strategy parameter. In FIG. 2, the subject strategy parameter will be set forth herein using five pulse widths, i.e., a pulse top width Top, a top cleaning pulse width Tpc, a multi pulse width Tmp, a last pulse width Tlw, and a cooling pulse width Tcw. Power-defining parameters such as a peak power Pp, an erase power Pe, a bias power Pb, ε, and the like, are added to the subject strategy parameter, and arbitrary two strategy parameters may be combined within all of these strategy parameters. The peak power Pp to melt a write area of the disk and the erase power Pe to crystallize the write area have the correlation therebetween, i.e., ε=Pe/Pp. The bias power Pb to form a recording mark through rapid cooling is assumed to be zero.

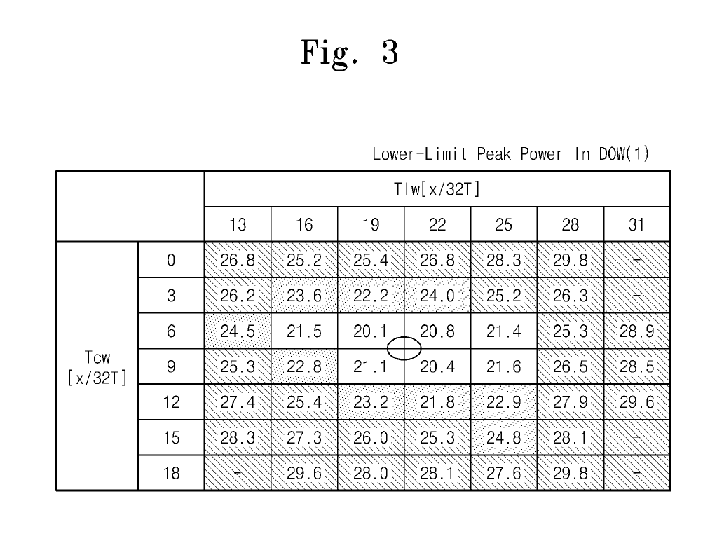

A method according to an exemplary embodiment of the inventive concept will be described below. FIG. 3 is a write quality table showing a lower-limit peak power enabling the write quality to be a desired limit value when a last pulse width and a peak power in DOW(1) change 2-dimensionally. In FIG. 3, it is assumed that the minimum point of the lower-limit peak power exists in a region where Tcw ranges from 6 to 9 and Tlw ranges from 19 to 22, which is shown as an ellipse in FIG. 3. The calculation of this minimum point by means of 2 dimensional 2-order approximation brings about Tlw=20.33, Tcw=7.72, and correlation coefficient=0.91. The optimal pulse width may be determined using this pulse width as pulse widths of the cooling pulse and the last pulse. This operation is repetitively performed on the combination of other strategy parameters, and thus the optimal pulse widths of all the subject strategy parameters may be determined. Also, since the write characteristic of DOW(1000) is not necessary, it is possible to adjust the strategy in a short time.

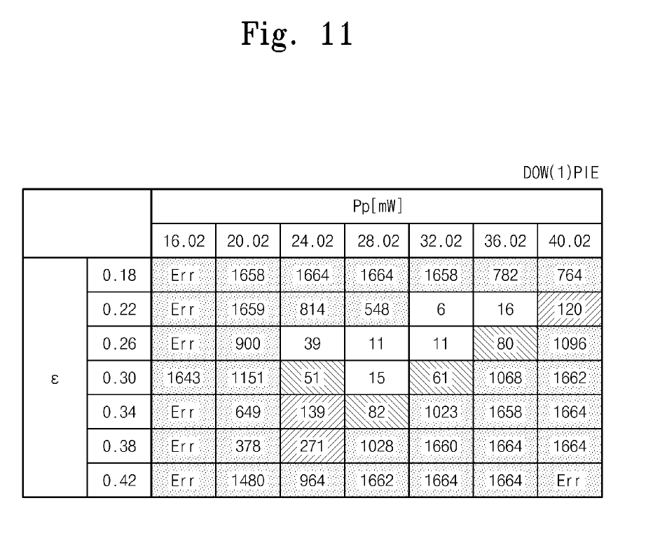

FIG. 11 is a write quality table showing a block error rate when ε and a peak power change 2-dimensionally. From this table, values determined by the 2-dimensional 2-order approximation are Pp=28.9 mW, and ε=0.27. To measure a matrix broadly and calculate the minimum position of PIE, a more accurate write power may be determined.

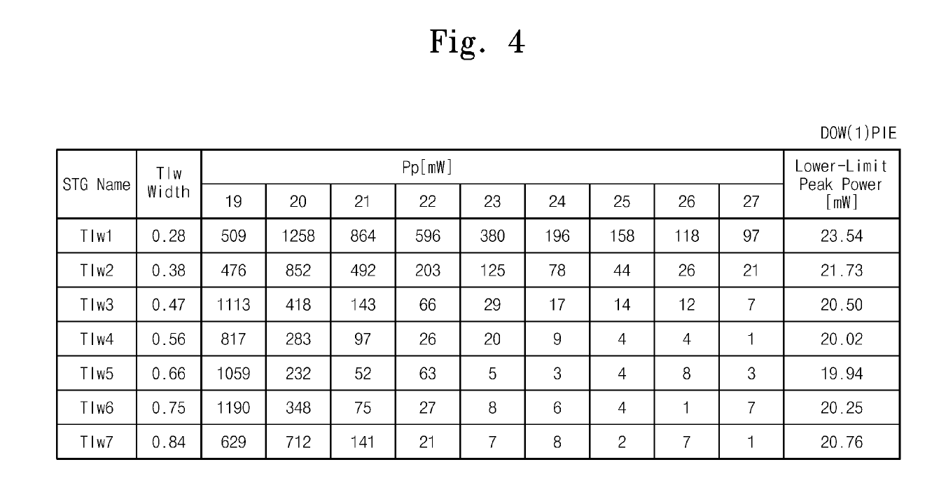

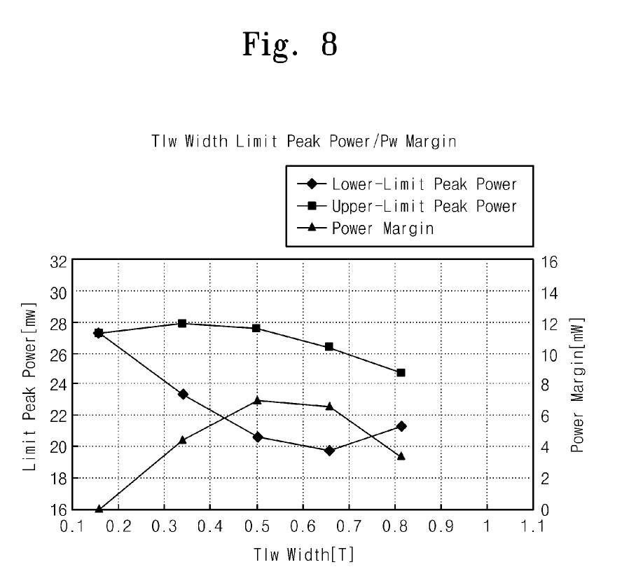

Next, a method according to another exemplary embodiment of the inventive concept will be described below. FIG. 4 is a write quality table showing a block error rate (PIE) of DOW(1) when a last pulse width and a peak power change 2-dimensionally, and also shows a lower-limit peak power for each last pulse width. In FIG. 4, a variation of a last pulse width Tlw of a lower-limit peak power Ppl is described in FIG. 8 in detail, but is similar to a power margin. Accordingly, it is possible to determine Tlw considering the relation between Tlw and Ppl. Also, this lower-limit peak power Ppl represents a write power that the write quality of DOW record becomes a desired limit value, and PIE may be substituted by jitter.

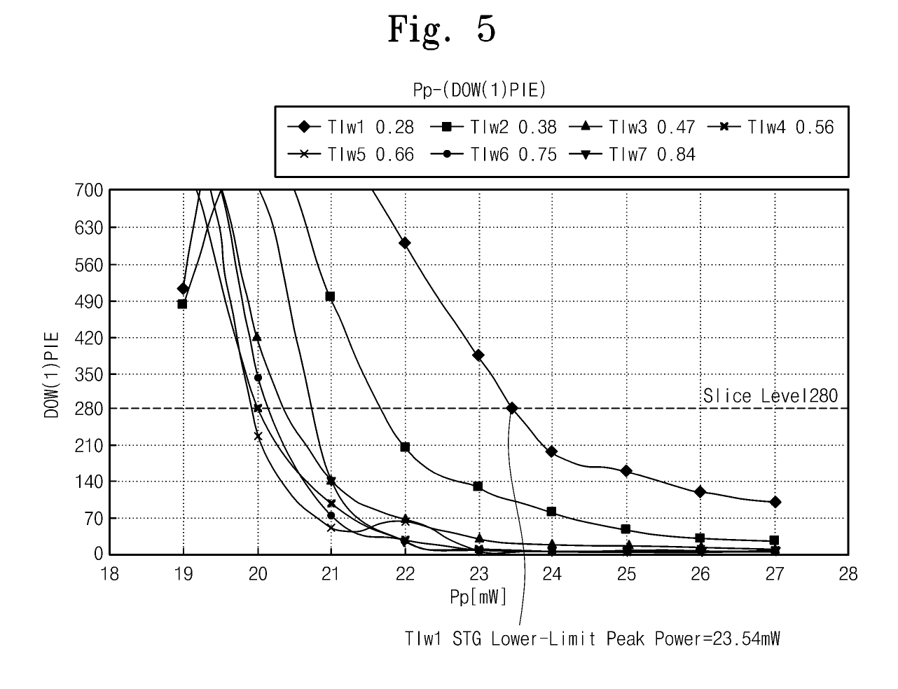

For this reason, a method of plotting a graph between Tlw and Ppl will be described. FIG. 5 is a graph illustrating Pp-PIE characteristics showing the relation between a peak power using a last pulse width as a parameter and a block error rate during DOW(1) write. In FIG. 5, noticed are intersections of a lower slice level 1280 of PIE, which is preset according to specification values, and each curve using Tlw as a parameter.

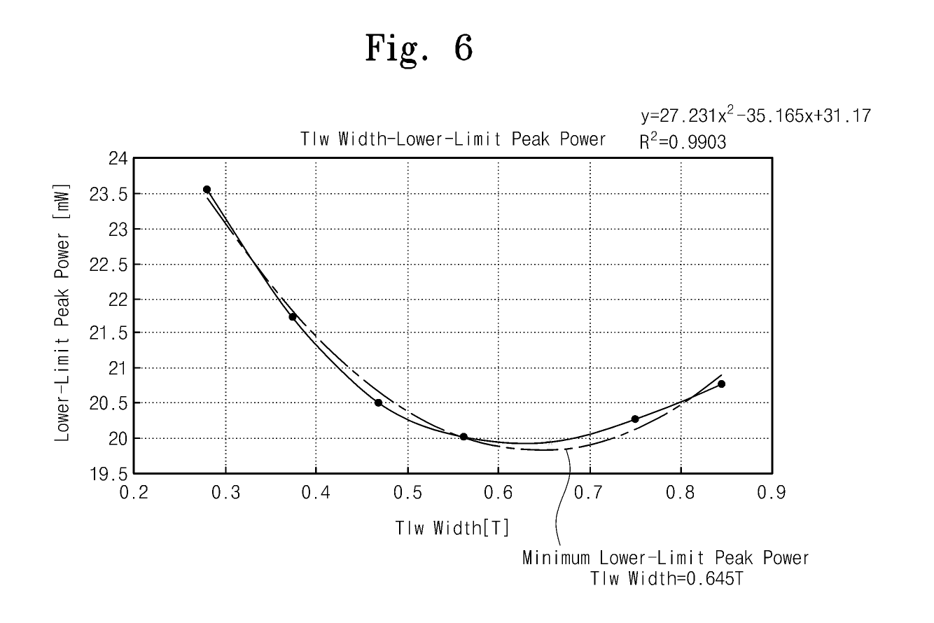

FIG. 6 is a graph illustrating Tlw-Ppl characteristics showing the relation between a last pulse width and a lower-limit peak power. In FIG. 6, a solid line is obtained by plotting Ppl determined from the intersections of each curve of FIG. 5 and the lower slice level 1280, and Tlw of the curve. A broken line denotes a quadratic function achieved by approximating the plotted curve, and the correlation coefficient is 0.9903. Also, a value of a pulse width is 0.645, which shows the minimum value by the approximation of the quadratic function. As a result, it is possible to obtain a quadratic curve of FIG. 6 through numerical calculation based on data collected in FIG. 5, and to automatically calculate Tlw. Hence, by repeating this operation on each strategy parameter, all strategy parameters can be determined in a short period of time and precisely using only DOW(1). DOW(1) may be DOW(50 or less).

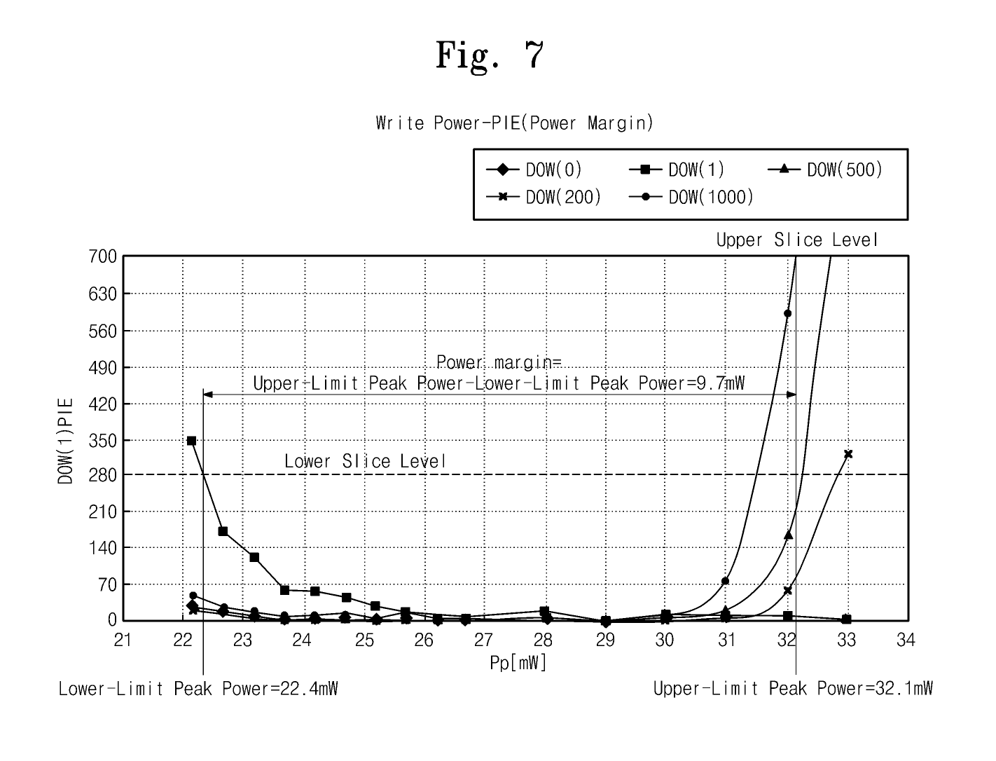

Next, a method according to still another exemplary embodiment of the inventive concept will be described. Also, the relation between a power margin and the upper-limit peak power Ppu and lower-limit peak power Ppl of the peak power Pp will be described. FIG. 7 is a power margin diagram showing the relation between a peak power and a block error rate when a rewrite number is used as a parameter. An upper slice level 1700 and a lower slice level 1280 of PIE are preset to a specification value.

In FIG. 7, from Pp and PIE in DOW(0) to DOW(1000), it is observed that Pp of DOW(1000) intersects the upper slice level 1700 first, and Ppu is set to 32.1 mW. Also, Pp of DOW(1) intersects the lower slice level 1280 of PIE first, and Ppl is set to 22.4 mW. From this, the power margin may equal to Ppu−Ppl=32.1−22.4=9.7 mW. The strategy adjustment of a rewritable disk requires much time to execute a necessary DOW(1000) write, in regard to a method of broadly adjusting this power margin. In FIG. 7, write characteristics of DOW(1) and DOW(1000) are in the relation of trade-off each other.

Still another exemplary embodiment of the inventive concept will be described. FIG. 8 is a graph showing the correlation among a lower-limit peak power when a last pulse changes in DOW(1), an upper-limit peak power when a last pulse changes in DOW(1000), and a power margin. In FIG. 8, Ppu and the power margin are approximated to a quadratic function having the minimum value for Tlw. On the other hand, Ppl is approximated to a quadratic function having the minimum value for Tlw, and has a significant peak in comparison with Ppu. Further, Tlw corresponding to the minimum Ppl and Tlw corresponding to the maximum power margin nearly coincides with each other. Rather, it is assumed that the power margin is maximized by computing Tlw corresponding to the minimum Ppl.

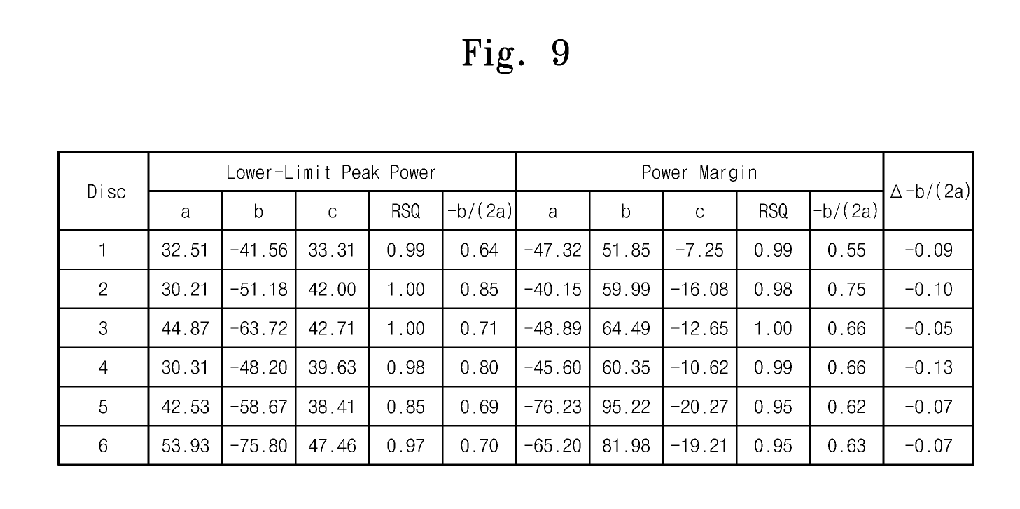

FIG. 9 is a maximum value table obtained by calculating Tlw corresponding to the minimum lower-limit peak power of each disk and Tlw corresponding to the maximum power margin, through a quadratic function. A difference (Δ−b/(2a)) between Tlw corresponding to the maximum power margin and Tlw corresponding to the minimum peak power is non-uniform, but −0.1 on the average. By subtracting a correction value from Tlw corresponding to the minimum Ppl using an absolute value of this average difference as a correction value, it is possible to obtain Tlw enabling the power margin to be enlarged. Here, the corrected Tlw is used to enlarge the power margin. For this reason, the optimal Tlw can be determined more precisely by calculating the correction value of Tlw and subtracting this correction value from Tlw corresponding to the minimum Ppl.

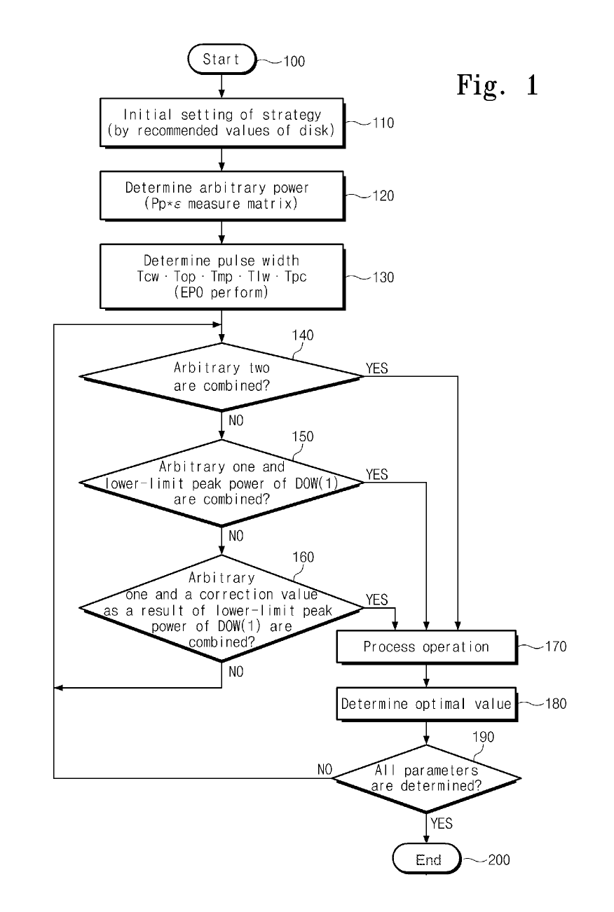

FIG. 1 is a flowchart illustrating a method of determining write strategy according to embodiments of the inventive concept. In FIG. 1, an initial setting of each strategy is performed on the basis of recommendation strategy of a disk or existing adjustment completion strategy, in operation 110. In operation 120, write quality is calculated by changing ε and Pp onto a 2-dimensional matrix based on this initial setting, and Pp and ε providing the best write quality. In operation 130, an edge position optimum (EPO) operation, which determines a pulse width of a subject strategy parameter, is initiated based on these Pp and ε. In operations 140, 170 and 180, thereafter, in case of the arbitrary combination of two of subject strategy parameters, write quality is calculated by changing it to a 2-dimensional matrix, and the optimal pulse width of the two subject strategy parameters corresponding to the best write quality of the 2-dimensional matrix is then determined. In operation 190, the same operation is repeated until all subject strategy parameters are determined.

In case of the combination of one arbitrary subject strategy parameter and a lower-limit peak power, the minimum value of the lower-limit peak power in DOW(1) is calculated by changing the pulse width of the one arbitrary subject strategy parameter, and the optimal pulse width of the one subject strategy parameter corresponding to the minimum value of the lower-limit peak power is then determined, in operations 150, 170 and 180. In operation 190, the same operation is repeated until all subject strategy parameters are determined.

In operations 160, 170 and 180, when the correction value is combined using one arbitrary subject strategy parameter and a lower-limit peak power, the minimum value of the lower-limit peak power in DOW(1) is calculated by changing the pulse width of the one arbitrary subject strategy parameter, and the optimal pulse width is determined by adding or subtracting a predetermined correction value to/from the pulse width of the one subject strategy parameter corresponding to the minimum power of the lower-limit peak power. In operation 190, the same process is repeated until all subject strategy parameters are determined.

As described above, according to the exemplary embodiments of the inventive concept, it is possible to provide a method of determining write strategy and an optical disk drive that can determine optimal write strategy for the optical disk drive having unknown write strategy in a short period of time and precisely.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A method of determining a write strategy of an optical disk drive in which a mark and a space are formed on an optical disk by a laser beam to display write information and information is written or reproduced, the method comprising:
evaluating write quality by combining at least two of power- and pulse-based parameters defining a writing multi pulse, and changing the at least two parameters on a 2-dimensional matrix; and
determining the power- and pulse-based parameters indicating a specific write quality as strategy parameters, based on evaluated results of the write quality.

2. The method of claim 1, wherein the evaluating of the write quality comprises calculating a write power that the write quality of a Direct Over Write (DOW) performing rewrite operation becomes a desired limit value, by changing a value of one of the at least two parameters.

3. The method of claim 2, wherein, during the determining of the parameters, one of parameters, which the write power corresponds to a target value, is determined as a strategy parameter.

4. The method of claim 3, further comprising:
determining a final strategy parameter by adding or subtracting a predetermined correction amount to/from one of the parameters.

5. The method of claim 2, wherein the rewrite time is once.

6. An optical disk drive in which a mark and a space are formed on an optical disk by a laser beam to display write information and information is written or reproduced, the optical disk drive comprising:
a write strategy operation control unit configured to write quality by combining at least two of power- and pulse-based parameters defining a writing multi pulse and changing the at least two parameters on a 2-dimensional matrix, and configured to determine the power- and pulse-based parameters indicating a specific write quality as strategy parameters, based on evaluated results of the write quality; and
a write pulse adjustment unit configured to generate and output a write pulse train by referring to the determined strategy parameter.

7. A method of determining a write strategy of an optical disk drive, the method comprising:
setting a write quality by changing values of at least two arbitrary parameters among power- and pulse-based strategy based parameters into a 2-dimensional matrix; and
determining optimal values of the power- and pulse-based strategy parameters indicating a specific write quality as strategy parameters, based on the set results of the write quality.

8. The method of claim 7, further comprising:
setting conditions for calculating a minimum value of a lower-limit peak power of DOW(1) or DOW(50 times or less) of one arbitrary parameter.

9. Them method of claim 7, further comprising:
correcting a strategy parameter corresponding to a minimum value of a lower-limit peak power.

10. An optical disk drive, comprising:
a write strategy operation control unit configured to set a write quality by changing values of at least two arbitrary parameters among power- and pulse-based strategy based parameters into a 2-dimensional matrix, and to determine optimal values of the power- and pulse-based strategy parameters indicating a specific write quality as strategy parameters, based on the set results of the write quality; and
a write pulse adjustment unit configured to generate and output a write pulse train by referring to the determined strategy parameter.
